(19) United States
(12) Patent Application Publication
(10) Pub. No.: US 2025/0381587 A1
(43) Pub. Date: Dec. 18, 2025

(54) Handheld device for removing debris from cords and hoses

(71) Applicant: Andrew Machalicek, Saginaw, TX (US)

(72) Inventor: Andrew Machalicek, Saginaw, TX (US)

(21) Appl. No.: 19/233,661

(22) Filed: Jun. 10, 2025

Related U.S. Application Data
(60) Provisional application No. 63/660,227, filed on Jun. 14, 2024.

(51) Int. Cl. B08B 9/023; B08B 1/14; B08B 1/30

(52) U.S. Cl. CPC B08B 9/023; B08B 1/14; B08B 1/30; B08B 2209/02

(57) ABSTRACT

A handheld cleaning device for hoses and cords includes an upper enclosing piece and a lower enclosing piece, each housing a corresponding semicylindrical filter foam. The enclosing pieces are connected via mandrel holders and a cylindrical mandrel, with a torsion spring positioned between them to bias the device toward a closed position. Upper and lower leverage handles are attached to the enclosing pieces and connected to the spring legs, allowing manual actuation between open and closed positions. The filter foam compresses around a hose or cord inserted through the interior cavity, enabling efficient and hygienic cleaning while reducing risk of user injury. The device is designed to securely envelop and clean hoses or cords of varying diameters by accommodating their shape and size through the flexible foam components.

### CROSS-REFERENCE TO RELATED APPLICATIONS

The application claims the benefit of U.S. Provisional Application No. 63/660,227, filed Jun. 14, 2024.

### BACKGROUND OF THE INVENTION

The present invention relates to cleaning devices for hoses and cords, and more particularly, a handheld device for removing debris from cords and hoses.

Cleaning hoses and cords can be a tedious and hazardous task due to their propensity to collect dirt, grime, and potentially harmful substances. The irregular surfaces and flexible nature of hoses and cords make them difficult to clean thoroughly, leading to inadequate sanitation and potential health risks. Moreover, not cleaning and sanitizing them carries the grave risk of contaminating other operating systems. Therefore, there is a pressing need for a specialized product that simplifies and secures the cleaning process of hoses and cords. Such a product would not only enhance efficiency but also ensure safety by reducing physical strain and minimizing exposure to hazardous materials.

Several devices have been created for a similar purpose. Some feature a housing made up of two halves that enclose a section of the cable to be cleaned. Examples of such designs can be found in patents U.S. Pat. Nos. 11,866,289, 11,852,234, GB 2493794, U.S. Pat. No. 4,169,427, and WO 2007/086865. While these existing devices have assemblies similar to the current invention—such as a top enclosure body hingedly attached to a bottom enclosure body to form a hollow interior—these devices make it difficult for the user to secure the hose to the device and release it from the device with ease and efficiency. None of them utilize a pressure-based leverage clamping mechanism that operates with the same degree of ease and efficiency.

### SUMMARY OF THE INVENTION

It should be appreciated that this Summary is provided to introduce a selection of concepts in a simplified form, further described below in the Detailed Description. This Summary is not intended to identify key features or essential features of this disclosure, nor is it intended to limit the scope of the invention.

Objectives of the present invention include: (1) providing a safer method of cleaning hoses and cords by preventing injury to hands during handling, (2) offering a more efficient and sanitizing cleaning process, and (3) preventing contamination of operating systems.

These and other objects are achieved by the present invention.

According to some embodiments of the present inventive concepts, the present invention comprises an upper enclosing piece, a lower enclosing piece, an upper filter foam, a lower filter foam, an upper leverage handle, a lower leverage handle, a torsion spring, a spring leg guide, four mandrel holders, and a mandrel.

According to some embodiments, the upper enclosing piece and lower enclosing piece are semicylindrical in shape and composed of ABS plastic or a similar plastic. The semicylindrical shape of the upper enclosing piece and the lower enclosing piece comprises a concave interior, a convex exterior, two ends, and two sides.

According to some embodiments of the present inventive concepts, the upper filter foam and lower filter foam are semicylindrical in shape and composed of 20 pores per inch (PPI) foam, though a different type of foam or a foam of other PPI level could be utilized. The semicylindrical shape of the upper filter foam and the lower filter foam comprises a convex exterior, a concave interior, two ends, and two sides. According to some embodiments, the purpose of the filter foam is to clean the hose or cord that is being guided through the present invention. In one embodiment, the filter foams are composed of foam because of their ability to contract and elongate to envelop cords and hoses of varied sizes.

According to some embodiments of the present inventive concepts, the mandrel is cylindrical in shape. In one embodiment, the diameter of the mandrel holder is slightly smaller than the diameter of the interior of the mandrel holder, though a smaller diameter of the mandrel could be utilized with a similar effect.

According to some embodiments of the present inventive concepts, the present invention has a closed position, wherein the sides of the upper enclosing piece are connected or are in proximity to both sides of the lower enclosing piece, and wherein the sides of the upper filter foam are connected to or are in proximity to both sides of the lower filter foam. In one embodiment, the closed position is similar to a closed clam shell.

According to some embodiments of the present inventive concepts, the present invention has an open position, wherein one side of the upper enclosing piece is in less proximity to one side of the lower enclosing piece than the closed position, and wherein one side of the upper filter foam is in less proximity to one side of the lower filter foam than the closed position. In one embodiment, this open position is similar to an open clam shell.

According to some embodiments of the present inventive concepts, the upper enclosing piece envelops the upper filter foam on its concave interior, and the lower enclosing piece envelops the lower filter foam on its concave interior.

According to some embodiments of the present inventive concepts, the upper leverage handle and lower leverage handle are composed of ABS plastic, although other similar materials may be used.

According to some embodiments of the present inventive concepts, the upper enclosing piece, the lower enclosing piece, and the mandrel holders are composed of ABS plastic, though another similar material could be utilized.

According to some embodiments of the present inventive concepts, the upper leverage handle is attached to one side of the upper enclosing piece, adjacent to the edge of the length side of the upper enclosing piece.

According to some embodiments of the present inventive concepts, the lower leverage handle is attached to one side of the lower enclosing piece, adjacent to the edge of the length side of the lower enclosing piece.

According to some embodiments of the present inventive concepts, a spring leg guide is attached to the upper leverage handle, the lower leverage handle, or both. In the preferred embodiment, the spring leg guide is attached to the lower leverage handle on the surface facing the upper leverage handle and is a thin rectangular protrusion.

According to some embodiments of the present inventive concepts, the torsion spring comprises a looped coil of metal wire, with the legs of the torsion spring extending from the looped coil, one spring leg extending at a 90 degree angle from the other spring leg, though alternative angles could be utilized to achieve a similar effect. In one embodiment, the torsion spring is composed of zinc-coated music wire.

According to some embodiments of the present inventive concepts, two hollow cylindrical mandrel holders are attached to the length side of the lower enclosing piece and the length side of the upper enclosing piece. In one embodiment, a mandrel is inserted through one cylindrical mandrel holder attached to the lower enclosing piece, then through one cylindrical mandrel holder attached to the upper enclosing piece, then through the looped coil of metal wire of the torsion spring, then through the other cylindrical mandrel holder attached to the upper enclosing piece, and then through the other cylindrical mandrel holder attached to the lower enclosing piece.

According to some embodiments of the present inventive concepts, the upper leverage handle is connected to one spring leg, and the lower leverage handle is connected to the other spring leg. In one embodiment, the spring leg is attached to the upper leverage handle and lower leverage handle by resting adjacent to one spring leg guide.

According to some embodiments of the present inventive concepts, applying opposing pressure to the upper leverage handle and lower leverage handles causes the present invention to move from its closed position to its open position.

According to some embodiments of the present inventive concepts, releasing pressure to the upper leverage handle and lower leverage handle causes the present invention to move from its open position to its closed position, which functions as to lock the invention around a hose or cord.

According to some embodiments of the present inventive concept, the upper filter foam and lower filter foam are hollowed on the interior for the placement of hoses or cords, forming a concave interior.

### BRIEF DESCRIPTION OF DRAWINGS

FIG. 1 is a top rear perspective exploded view of the cleaning device.

FIG. 2 is a side orthogonal exploded view of the cleaning device.

FIG. 3 is a top front perspective exploded view of the cleaning device.

FIG. 4 is a side orthogonal view of either the upper filter foam or the lower filter foam.

FIG. 5 is a side orthogonal view of the torsion spring.

FIG. 6 is a front orthogonal view of the torsion spring.

FIG. 7 is a top front perspective view of the torsion spring.

FIG. 8 is a side orthogonal view of the upper enclosing piece, one of the mandrel holders, and the upper leverage handle.

FIG. 9 is an expanded side orthogonal view of the upper enclosing piece, one of the mandrel holders, and the upper leverage handle.

FIG. 10 is a top perspective view of the upper enclosing piece and the upper leverage handle.

FIG. 11 is a side orthogonal view of the lower enclosing piece, one of the mandrel holders, and the lower leverage handle.

FIG. 12 is an expanded side orthogonal view of the lower enclosing piece, one of the mandrel holders, and the lower leverage handle.

FIG. 13 is a top rear perspective view of the lower enclosing piece, the mandrel holders, and the lower leverage handle.

FIG. 14 is a top rear perspective view of the cleaning device in the closed position.

### DETAILED DESCRIPTION OF THE INVENTION

Various exemplary embodiments of the present invention are illustrated in the following description.

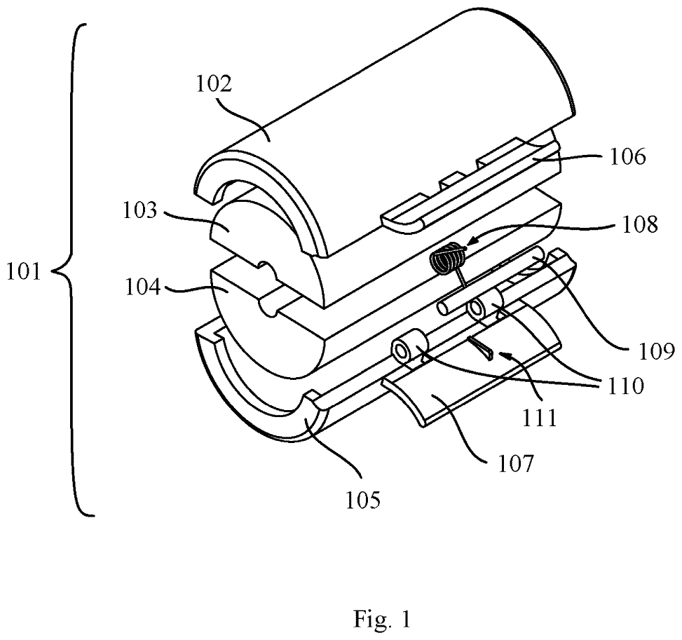

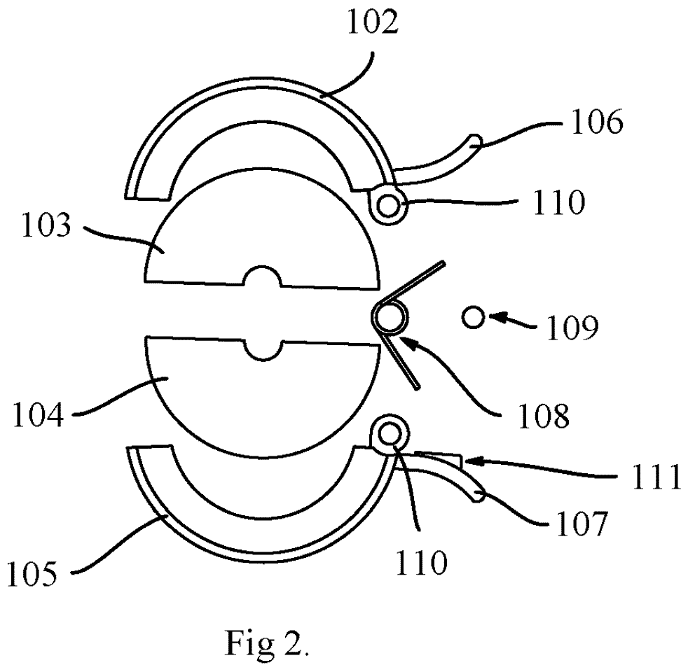

FIG. 1 illustrates a complete drawing of the invention at hand 101 including most components, comprising an upper enclosing piece 102, an upper filter foam 103, a lower filter foam 104, a lower enclosing piece 105, an upper leverage handle 106, a lower leverage handle 107, a torsion spring 108, and mandrel holders 110. In the preferred embodiment, the upper enclosing piece 102, the lower enclosing piece 105, the upper leverage handle 106, the lower leverage handle 107, the spring leg guide 111, and the mandrel holders 110 are composed of ABS plastic, the filter foams are 20 Pores Per Inch (PPI), and the mandrel is composed of brass. Two mandrel holders 110 are not visible in FIG. 1 but are visible in FIG. 2. In the preferred embodiment, there are two mandrel holders 110 connected to the upper enclosing piece 102 on the side where the upper leverage handle 106 is attached to the upper enclosing piece 102, and two mandrel holders 110 connected to the lower enclosing piece 105 on the side where the lower leverage handle 107 is connected to the lower enclosing piece 105. In the preferred embodiment, the upper leverage handle 106 is attached along the length side of the upper enclosing piece 102, and the lower leverage handle 107 is attached to the lower enclosing piece 105 on its length side. In the preferred embodiment, the sides of the upper enclosing piece 102, the lower enclosing piece 105, the upper filter foam 103, and the lower filter foam 104 are parallel to each other. In the preferred embodiment, the two mandrel holders 110 of the upper enclosing piece 102 are closer together than the two mandrel holders of the lower enclosing piece 105, such that the mandrel holders 110 of the upper enclosing piece 102 can be placed next to and within the mandrel holders 110 of the lower enclosing piece 105, such that the mandrel 109 can be inserted through the aligned interiors of the mandrel holders 110. In the preferred embodiment, the torsion spring 108 fits between the mandrel holders 110 of the upper enclosing piece 102 and the lower enclosing piece 105, such that the mandrel 109 can be placed through the looped coil 302 of the torsion spring 108 and all the mandrel holders 110. In the preferred embodiment, one of the torsion spring legs 301 rests adjacent to the spring leg guide on the lower leverage handle 107.

FIG. 2 depicts the same components as FIG. 1 from a different view and depicts one of the mandrel holders 110 attached to the upper enclosing piece 102.

FIG. 3 depicts the same or fewer components as FIG. 1 from a different view.

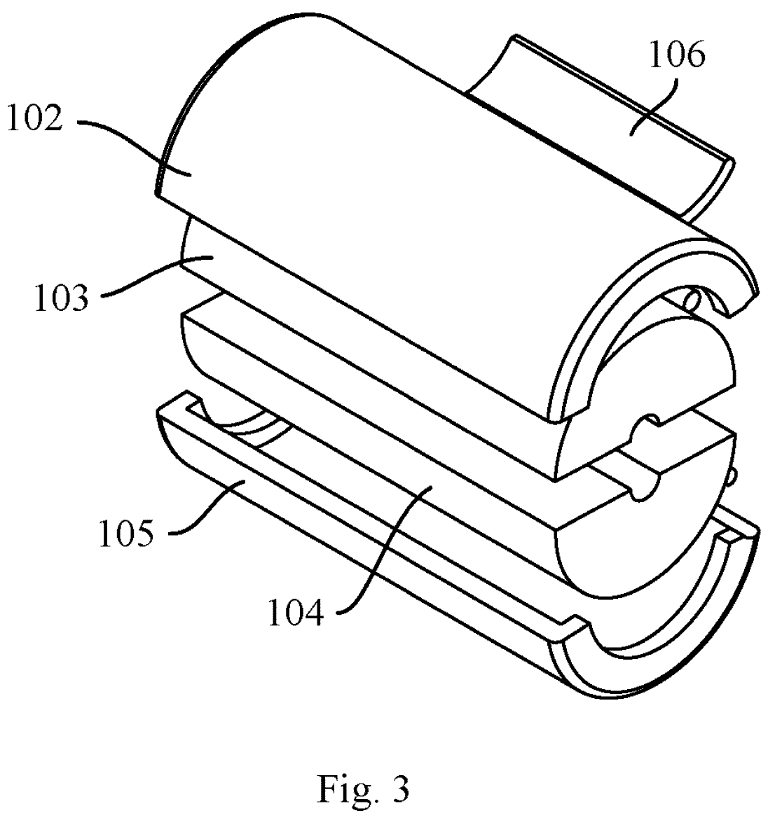

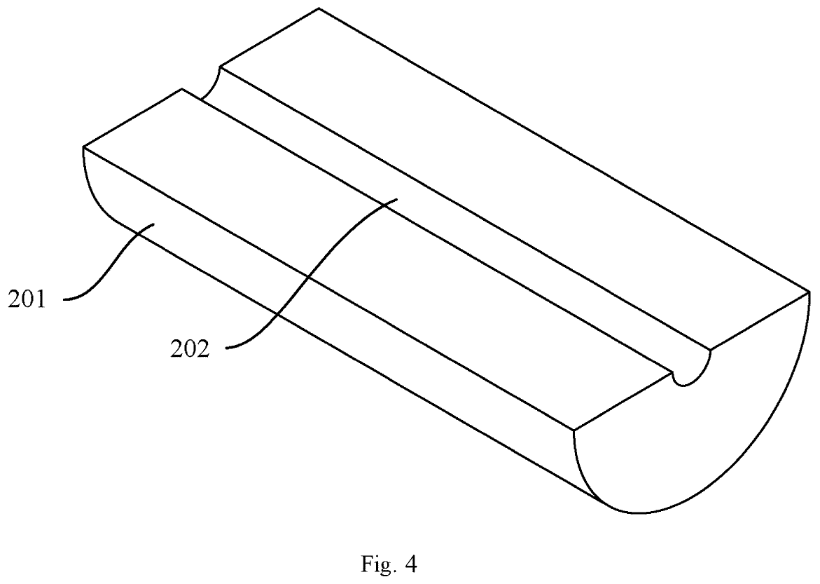

FIG. 4. depicts either the lower filter foam 103 or the upper filter foam 104, each referred to as a filter foam. There is a concave interior 202 for receiving the elongated object, and a convex exterior 201 for interfacing with the enclosing piece. The concave interior 202 envelops the placed elongated object to be cleaned when placed inside.

In the preferred embodiment, the length of the mandrel 109 is 1.328 inches and the diameter is 0.137 inches.

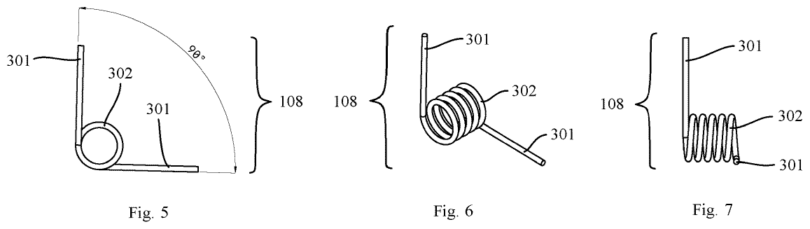

FIG. 5 depicts the torsion spring 108, comprising two spring legs 301 and one looped coil 302. In the preferred embodiment, the angle of separation between the two spring legs 301 is 90 degrees, the length of the spring legs 301 is 0.5 inches from the center of the looped coil 302, and the diameter of the wire comprising the torsion spring 108 is 0.03 inches.

FIG. 6 depicts the same components as FIG. 5 from a different view. In the preferred embodiment, the length of the looped coil is 0.28 inches.

FIG. 7 depicts the same components as FIG. 5 from a different view.

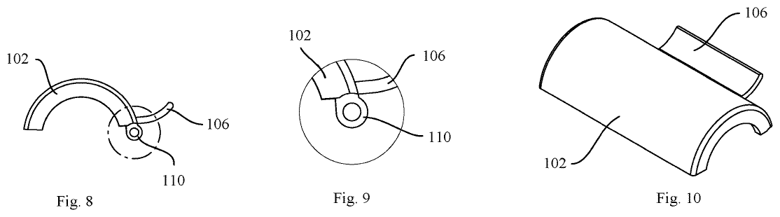

FIG. 8 depicts the upper enclosing piece 102, one of the mandrel holders 110, and the upper leverage handle 106. FIG. 8 also depicts the axis of rotation of these components, which runs through the mandrel 109 and allows the upper and lower enclosing pieces to pivot relative to one another when opposing pressure is applied to the upper leverage handle 106 and the lower leverage handle 107.

FIG. 9 is a magnified view of the same components in FIG. 8.

FIG. 10 depicts the upper enclosing piece 102 and the upper leverage handle 106.

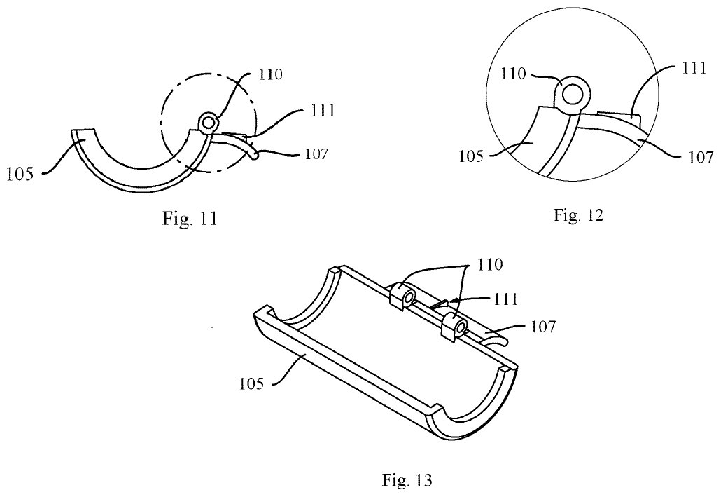

FIG. 11 depicts the lower enclosing piece 105, the mandrel holders 110, the lower leverage handle 107, and the spring leg guide 111.

FIG. 12 depicts the lower enclosing piece 105, the mandrel holders 110, the lower leverage handle 107, and the spring leg guide 111, in an expanded view.

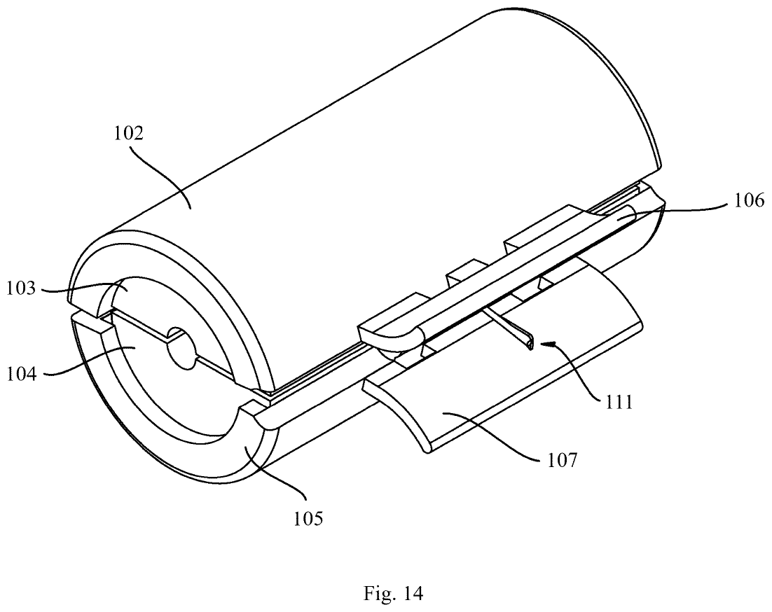

FIG. 13 depicts the lower enclosing piece 105, the mandrel holders 110, the lower leverage handle 107, and the spring leg guide 111. In the preferred embodiment, the spring leg guide is attached to the lower leverage handle in such a manner that the spring leg 301 sits adjacent to it on the side closer to the middle of the lower leverage handle.

FIG. 14 depicts the present invention in the closed position, and depicts the upper enclosing piece 103, the lower enclosing piece 105, the upper filter foam 103, the lower filter foam 104, the upper leverage handle 106, the lower leverage handle, and the spring leg guide 111.

PPI stands for “Pores Per Inch,” indicating the foam's cell count. In the preferred embodiment, the present invention comprises two semicircular foam pieces with a PPI of 20±5, meaning there are between 15 and 25 pores per inch.

In the preferred embodiment, the density of the filter foams is PCF 1.4+/−0.10, with the compression set at 50%: 15% max. “Compression set at 50%: 15% max” means that when the foam is compressed to 50% of its original thickness and then released, it will not remain compressed by more than 15% of its original thickness. In other words, the foam can recover at least 85% of its original thickness after being compressed.

In the preferred embodiment, the mentioned foams have a minimum tensile strength of 18 pounds per inch (LB/IN). This indicates the maximum amount of force the material can withstand when being pulled or stretched before breaking.

In the preferred embodiment, the mentioned foams have a minimum elongation of 180% before breaking. This measurement signifies the maximum stretch the material can undergo before reaching its breaking point. A different strength of elongation could be used to similar effect.

In the preferred embodiment, the mentioned foams have a minimum tear strength of 5.0 pounds per inch (LB/IN). This measurement signifies the maximum force required to tear the material apart. A different tear strength level could be used to similar effect.

In the preferred embodiment, the mentioned foams have a volumetric air flow ranging from 18.5 to 25.5 cubic feet per minute (CFM). This measurement indicates the capacity of air flow through the material. A different volumetric air flow could be used to similar effect.

In the preferred embodiment, as shown in FIG. 2, the present invention consists of two semicircular filter foams 103 104, each with a semicircular cavity, or concave interior 202, at the center. Each filter foam 103 104 has a length of 3.250 inches, with a 0.655-inch thickness between the outer and inner edges.

Embodiments of the present invention have been discussed with particular reference to the examples illustrated. However, it will be appreciated that variations and modifications may be made to the examples described within the scope of the invention.

1. A device for cleaning an elongated object such as a cord, cable, or hose, comprising:
an upper segment;
a lower segment;
an upper leverage handle;
a lower leverage handle;
wherein applying opposing pressure to the upper leverage handle and lower leverage handle moves the upper segment and lower segment to an open position to receive the elongated object;
wherein releasing pressure from the upper leverage handle and lower leverage handle moves the upper segment and lower segment to a closed position to engage the elongated object;
wherein the device is configured to be slid along the length of the elongated object.

2. The device of claim 1, wherein the upper segment comprises an upper enclosing piece and an upper filter foam, and the lower segment comprises a lower enclosing piece and a lower filter foam.

3. The device of claim 2, wherein the upper leverage handle and two mandrel holders are attached to one side of the upper enclosing piece, and the lower leverage handle and two mandrel holders are attached to one side of the lower enclosing piece.

4. The device of claim 3, wherein the mandrel holders connected to the upper enclosing piece and lower enclosing piece are aligned with one another, a torsion spring is positioned adjacent to the mandrel holders, and a mandrel is placed through the mandrel holders and the torsion spring.

5. The device of claim 4, wherein the torsion spring has two spring legs that are connected to the upper leverage handle and lower leverage handle, with one of the spring legs resting adjacent to a spring leg guide protruding from one of the leverage handles.

6. The device of claim 2, wherein the upper enclosing piece, the upper filter foam, the lower enclosing piece, and the lower filter foam are semicylindrical in shape with a concave interior.

7. The device of claim 1, wherein the upper leverage handle and lower leverage handle are designed to facilitate ease of use and provide sufficient leverage for opening and closing the upper and lower segments.

8. The device of claim 2, wherein the upper filter foam and lower filter foam are replaceable.

9. The device of claim 1, further comprising a locking mechanism to retain the upper and lower segments in the closed position during the cleaning process.

10. The device of claim 1, wherein the upper filter foam and lower filter foam are contoured to fit a variety of cable or hose diameters.

11. A method of cleaning an elongated object using the device of claim 1, comprising:
applying pressure to the upper leverage handle and lower leverage handle to move the upper segment and lower segment to an open position;
placing the elongated object between the upper segment and lower segment;
releasing the pressure on the leverage handles to move the upper segment and lower segment to a closed position;
sliding the device along the length of the elongated object.

12. The method of claim 11, further comprising applying pressure to the leverage handles to open the upper and lower segments and remove the elongated object.

13. The method of claim 11, wherein the upper segment comprises an upper enclosing piece and an upper filter foam, and wherein the lower segment comprises a lower enclosing piece and a lower filter foam.

14. A method for manufacturing a device for cleaning an elongated object, comprising:
attaching an upper segment to an upper leverage handle;
attaching a lower segment to a lower leverage handle;
attaching the upper segment to the lower segment.

15. The method of claim 14, wherein the upper segment comprises an upper enclosing piece and an upper filter foam, and the lower segment comprises a lower enclosing piece and a lower filter foam.

16. The method of claim 15, further comprising attaching the upper leverage handle to the upper enclosing piece and attaching the lower leverage handle to the lower enclosing piece.

17. The method of claim 16, further comprising attaching two mandrel holders to the upper enclosing piece and attaching two mandrel holders to the lower enclosing piece.

18. The method of claim 17, further comprising placing a mandrel through the mandrel holders and a torsion spring.

19. The method of claim 18, further comprising connecting one spring leg of the torsion spring to the upper leverage handle and connecting the other spring leg of the torsion spring to the lower leverage handle.

20. The method of claim 19, wherein either the upper leverage handle or lower leverage handle has a spring leg guide positioned adjacent to one of the torsion spring legs.
